(19) United States
(12) Patent Application Publication
(10) Pub. No.: US 2019/0064704 A1
(43) Pub. Date: Feb. 28, 2019

(54) TONER CONTAINER, IMAGE FORMING APPARATUS

(71) Applicant: KYOCERA Document Solutions Inc., Osaka (JP)

(72) Inventor: Kentaro Kishida, Osaka (JP)

(21) Appl. No.: 16/108,639

(22) Filed: Aug. 22, 2018

(30) Foreign Application Priority Data
Aug. 31, 2017 (JP) 2017-166504

(51) Int. Cl. G03G 15/16; G03G 15/08; G03G 15/20

(52) U.S. Cl. CPC G03G 15/16; G03G 15/2053; G03G 15/0865

(57) ABSTRACT

A toner container according to an aspect of the present disclosure is configured to be removably attached to a container attaching portion of an image forming apparatus. The toner container includes a substrate on which a storage portion is mounted. The substrate is attached on a surface of a body of the toner container, and a compatible key is formed integrally on the substrate, the compatible key being configured to allow the toner container to be selectively attached to the container attaching portion.

### INCORPORATION BY REFERENCE

This application is based upon and claims the benefit of priority from the corresponding Japanese Patent Application No. 2017-166504 filed on Aug. 31, 2017, the entire contents of which are incorporated herein by reference.

### BACKGROUND

The present disclosure relates to an image forming apparatus including a toner container having attachment compatibility, and a container attaching portion to which the toner container is removably attached.

The electrophotographic image forming apparatus includes the container attaching portion to which the toner container is attached, and the toner container is configured to be attachable to the container attaching portion. The toner container is provided with a toner discharge port for discharging toner, and a shutter member for opening and closing the toner discharge port. When the toner container is attached to the container attaching portion, the shutter member moves to an open position, the toner discharge port is opened, and toner can be replenished from the toner container to a developing device. In addition, the toner container is configured to be removably attached to the container attaching portion of the image forming apparatus, and when all of the toner inside the toner container has been consumed, the toner container is replaced with a new, full toner container.

Meanwhile, there is known a structure (incompatible structure) that, in order to prevent incompatible toner from being replenished to the developing device due to erroneous attachment to the container attaching portion, allows the toner container to be attached only to the container attaching portion with which the toner container has attachment compatibility, and does not allow the toner container to be attached to another noncorresponding toner attaching portion with which the toner container is incompatible. The incompatible structure is realized by a container-side compatible key provided on the toner container, and an apparatus-side compatible key provided on the container attaching portion. The incompatible structure allows attachment of a specific toner container only to the container attaching portion to which the toner container corresponds to, and interference between the compatible keys prevents attachment of the specific toner container to other container attaching portions.

In addition, conventionally, there is known a toner container having an IC chip that includes a memory (storage portion) in which information, such as amount of toner contained in the toner countainer, is stored. For example, the IC chip may be a substrate on which the memory is mounted, and the substrate may be attached on a surface (a bottom or side surface) of the toner container. When this toner container is attached to a container attaching portion of an image forming apparatus, an apparatus-side contact terminal, provided on the container attaching portion, is electrically connected with a contact terminal provided on the substrate of the IC chip. With this configuration, the image forming apparatus can acquire data, including information such as the amount of toner contained in the toner container, from the IC chip of the toner container.

### SUMMARY

A toner container according to an aspect of the present disclosure is configured to be removably attached to a container attaching portion of an image forming apparatus. The toner container includes a substrate on which a storage portion is mounted. The substrate is attached on a surface of a body of the toner container, and a compatible key is formed integrally on the substrate, the compatible key being configured to allow the toner container to be selectively attached to the container attaching portion.

An image forming apparatus according to another aspect of the present disclosure includes a toner container, and a container attaching portion to which the toner container is configured to be removably attached. The toner container includes a substrate on which a storage portion is mounted, and a compatible key. The substrate is attached on a surface of a body of the toner container. The compatible key, formed integrally on the substrate, is configured to allow the toner container to be selectively attached to the container attaching portion. The container attaching portion includes a compatible member. The compatible member includes a compatible engaging portion configured to engage only with the compatible key of the toner container having attachment compatibility with the container attaching portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective diagram showing an image forming apparatus according to an embodiment of the present disclosure.

FIG. 2 is a diagram showing an internal configuration of an image forming portion included in the image processing apparatus.

FIG. 3 is a perspective diagram showing a state in which a toner container is supported by a support frame of a toner storing portion for yellow.

FIG. 4 is a perspective diagram of a toner container for yellow.

FIG. 5 is a perspective diagram of a support frame for yellow.

FIG. 6A is a schematic diagram showing a pre-engaged state of a compatible member of a toner storing portion for yellow and a container-side compatible key of a toner container for yellow, and FIG. 6B is a schematic diagram showing an engaged state of the compatible member of the toner storing portion for yellow and the container-side compatible key of the toner container for yellow.

FIG. 7A to FIG. 7C are schematic diagrams showing compatible members of toner storing portions and container-side compatible keys of toner containers for colors besides yellow.

FIG. 8A to FIG. 8C are schematic diagrams showing states where attachment of the toner containers for colors besides yellow to the toner storing portion for yellow is prohibited.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

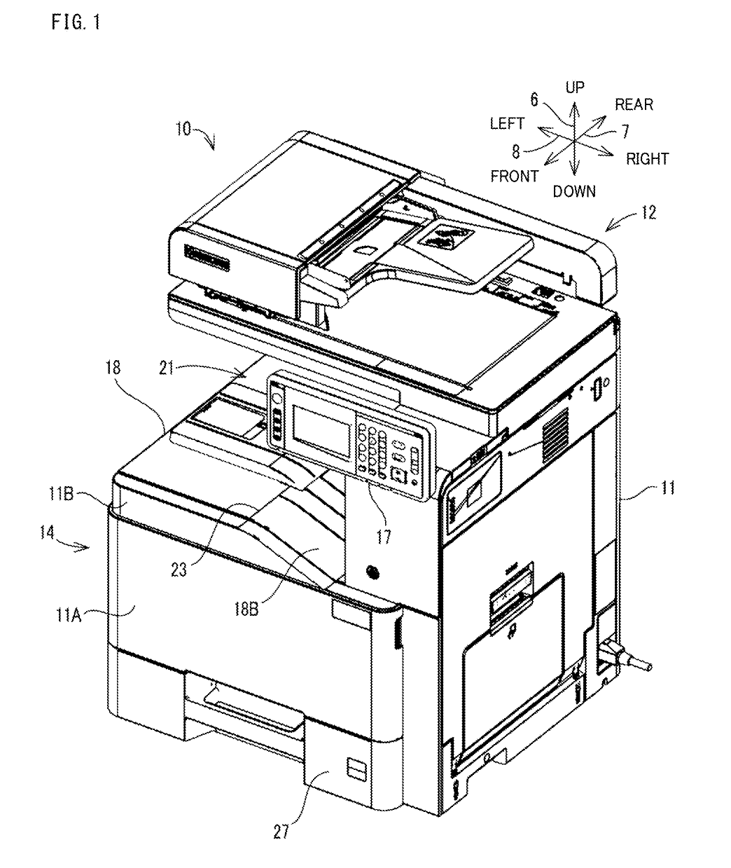

FIG. 1 is a diagram showing a configuration of an image forming apparatus 10 according to an embodiment of the present disclosure. It is noted that for convenience of explanation, a vertical direction in an installation state (shown in FIG. 1) where the image forming apparatus 10 is installed in a usable manner is defined as an up-down direction 6. In addition, a front-rear direction 7 is defined on the basis that a side on which an operation/display portion 17 is provided in the installation state is the front side (front face). In addition, a left-right direction 8 is defined with reference to the front face of the image forming apparatus 10 in the installation state.

As shown in FIG. 1, the image forming apparatus 10 is a multifunctional peripheral, and includes various functions such as a print function, a copy function, a facsimile function, and a scan function. The image forming apparatus 10 is not limited to a multifunctional peripheral, and may be a printer or a FAX apparatus having a print function.

The image forming apparatus 10 includes an image reading portion 12 and an image forming portion 14. The image reading portion 12 is configured to read an image from a document, and is provided in an upper portion of the image forming apparatus 10. The image forming portion 14 is configured to electrophotographically form a color image, and is provided in a lower portion of the image forming apparatus 10.

The image forming portion 14 includes a housing 11 as an apparatus body. Inside the housing 11, multiple parts constituting the image forming portion 14 are disposed. The housing 11 is composed of an external frame entirely covering the image forming portion 14, and an inner frame for supporting the multiple parts constituting the image forming portion 14. The housing 11 as a whole has an approximately rectangular parallelepiped shape.

A discharge space 21 is provided above the image forming portion 14. A sheet member on which an image has been formed is discharged to the discharge space 21 from a sheet discharge port 15 formed in the housing 11.

The housing 11 has a front cover 11A, and a side cover 11B provided above the front cover 11A. A front opening (not shown) formed on a front face of the housing 11 is covered by the front cover 11A and the side cover 11B.

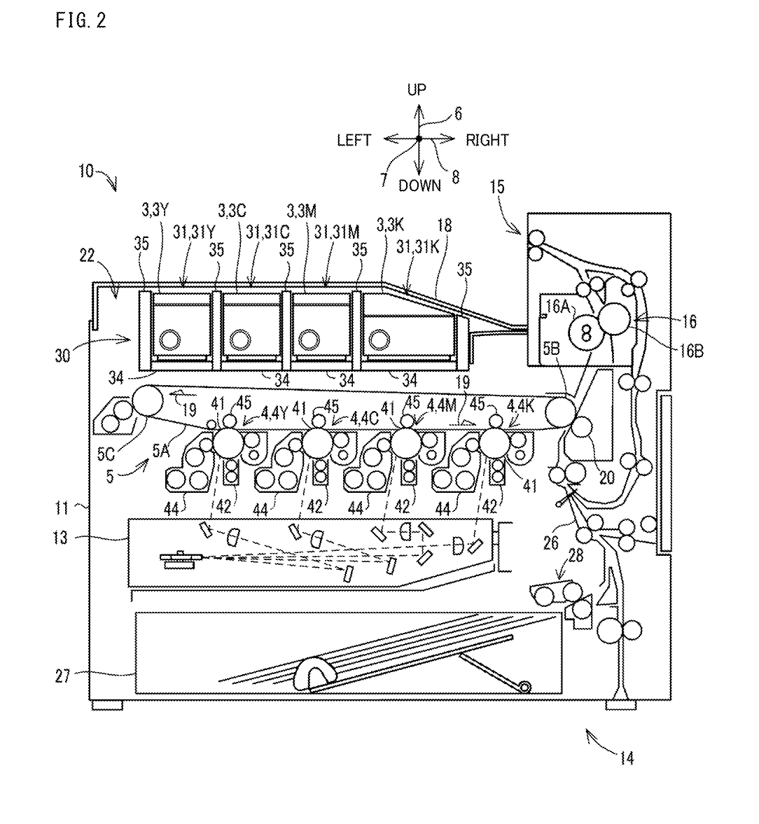

FIG. 2 is a diagram showing an internal configuration of the image forming portion 14. In FIG. 2, the image reading portion 12 is not shown. The image forming portion 14 forms the color image on the sheet member, such as printing paper, based on a so-called tandem system. As shown in FIG. 2, the image forming portion 14 includes four image forming units 4, an intermediate transfer unit 5, an optical scanning device 13, a secondary transfer roller 20, a fixing device 16, a sheet tray 18, a sheet cassette 27, a feeding unit 28, the operation display portion 17 (see FIG. 1), a conveyance path 26, a container attaching portion 30, four toner containers 3 (an example of the toner container of the present disclosure), and a control portion (not shown).

The plurality of image forming units 4 (4Y, 4C, 4M, 4K) are provided on the underside of the intermediate transfer unit 5. The four image forming units 4 are juxtaposed along a traveling direction (indicated by an arrow 19) of a transfer belt 5A, disposed in line from left to right along the transfer belt 5A in the following order: an image forming unit 4Y for yellow, an image forming unit 4C for cyan, an image forming unit 4M for magenta, and an image forming unit 4K for black. The plurality of image forming units 4 each include a photoconductor drum 41, a charging device 42, a developing device 44, and a primary transfer roller 45. The image forming unit 4Y forms a toner image on a surface of the photoconductor drum 41 using yellow toner. The image forming unit 4C uses cyan toner, the image forming unit 4M uses magenta toner, and the image forming unit 4K uses black toner to form toner images on the surfaces of the respective photoconductor drums 41. Development of the toner images on the photoconductor drums 41 is performed by the developing devices 44.

As shown in FIG. 2, the intermediate transfer unit 5 includes the transfer belt 5A, a driving roller 5B, and a driven roller 5C. The transfer belt 5A, provided on top of the photoconductor drums 41, is a belt member to which the toner images of each color formed on the photoconductor drums 41 of the image forming units 4 are transferred. The transfer belt 5A is rotatably supported by the driving roller 5B and the driven roller 5C, in a way that the transfer belt 5A is bridged between the driving roller 5B and the driven roller 5C that are provided apart from each other in the left-right direction 8. The transfer belt 5A is configured to pass through between the photoconductor drums 41 and the primary transfer rollers 45, and during this movement, the toner images are sequentially transferred from the photoconductor drums 41 to a surface of the transfer belt 5A to be superposed thereon.

The sheet member to which the toner image has been transferred by the secondary transfer roller 20 is conveyed to the fixing device 16. The fixing device 16 is configured to heat the toner image transferred on the sheet member to fix the toner image to the sheet member, and includes a heating roller 16A and a pressure roller 16B. The toner image transferred on the sheet member is heated by receiving heat from the heating roller 16A while passing through the fixing device 16. Accordingly, the toner image is fixed on the sheet member. Thereafter, the sheet member is discharged to the sheet tray 18.

As shown in FIG. 2, the sheet tray 18 is provided in the discharge space 21. The sheet tray 18 also serves as a part of the external frame constituting an upper surface of the image forming portion 14. As shown in FIG. 1 and FIG. 2, the sheet tray 18 has an inclined surface extending obliquely upward toward a left side from an end portion on a side of the sheet discharge port 15. The sheet tray 18 is configured to hold the sheet member discharged out of the sheet discharge port 15 via the fixing device 16. Sheet members discharged to the sheet tray 18 are stacked upwards.

As shown in FIG. 2, a storing space 22 is formed between the intermediate transfer unit 5 and the sheet tray 18. The container attaching portion 30 is provided in the storing space 22. That is, the sheet tray 18 is provided above the container attaching portion 30, and the intermediate transfer unit 5 is provided below the container attaching portion 30.

The container attaching portion 30 is fixed to the inner frame of the housing 11. Four toner containers 3 (3Y, 3C, 3M, 3K) are removably attached to the container attaching portion 30. That is, the toner containers 3 are removably attached to the image forming apparatus 10 by the container attaching portion 30. It is noted that of the four toner containers 3, the toner container 3Y contains yellow toner, the toner container 3C contains cyan toner, the toner container 3M contains magenta toner, and the toner container 3K contains black toner.

The container attaching portion 30, configured to store the toner containers 3 of the four colors, includes four toner storing portions 31 (an example of the container attaching portion of the present disclosure) to which the toner containers 3 are attached. The four toner storing portions 31 correspond to the toner containers 3 of the four colors. The toner containers 3 are attached to their respective corresponding toner storing portions 31 at specified attachment positions inside the toner storing portions 31.

The container attaching portion 30 supports the toner containers 3 in a way that the toner containers 3 are slidable in the front-rear direction 7 in and out of the four toner storing portions 31 (31Y, 31C, 31M, 31K). Each toner storing portion 31 has an opening on a front side, and slidably supports, along the front-rear direction 7, the toner container 3 inserted rearward from the opening. The four toner storing portions 31 are juxtaposed in the left-right direction 8. The toner storing portions 31 are partitioned by five partition walls 35, juxtaposed in the left-right direction 8, and four support frames 34 that are respectively provided in the toner storing portions 31. The support frame 34, configured to slidably support the toner container 3, is a bottom plate of the toner storing portion 31.

As shown in FIG. 2, the toner storing portion 31K on a rightmost side of the container attaching portion 30 is shaped differently from the other three toner storing portions 31Y, 31C, and 31M. The toner storing portion 31K stores the toner container 3K containing black toner. Since the black toner contained in the toner container 3K has the highest consumption amount, the toner container 3K has a larger volume than the other toner containers 3 (3Y, 3C, 3M). Since the toner storing portion 31K for black is formed in conformity with the toner container 3K, the toner storing portion 31K is also larger than the other toner storing portions 31Y, 31C, and 31M.

In the present embodiment, the toner containers 3Y, 3C, 3M and their toner storing portions 31Y, 31C, 31M are substantially the same in shape, except for a part. As described below, the toner containers 3 and the toner storing portions 31 have structures (hereinafter referred to as incompatible structures) that allow toner containers 3 to be attached only to their respective corresponding toner storing portions 31 with which the toner containers 3 have attachment compatibility, and do not allow the toner containers 3 to be attached to noncorresponding toner storing portions 31 with which the toner containers 3 are incompatible. Portions forming the incompatible structures in the toner containers 3 and toner storing portions 31 are different from each other in mechanism.

Meanwhile, a conventional toner container includes, as individual entities, a compatible key for realizing the so-called incompatible structure, and a substrate on which a storage portion, for storing information such as an amount of toner contained in the toner container, is mounted. In this case, it is necessary to determine attachment positions respectively for the compatibility key and the substrate on the toner container. Specifically, it is necessary to attach the compatible key and the substrate such that the substrate and an apparatus-side compatible key do not interfere with each other, or a container-side compatible key and an apparatus-side contact terminal do not interfere with each other. This causes a problem that the degree of freedom in selecting attachment positions for the compatible key and the substrate is low.

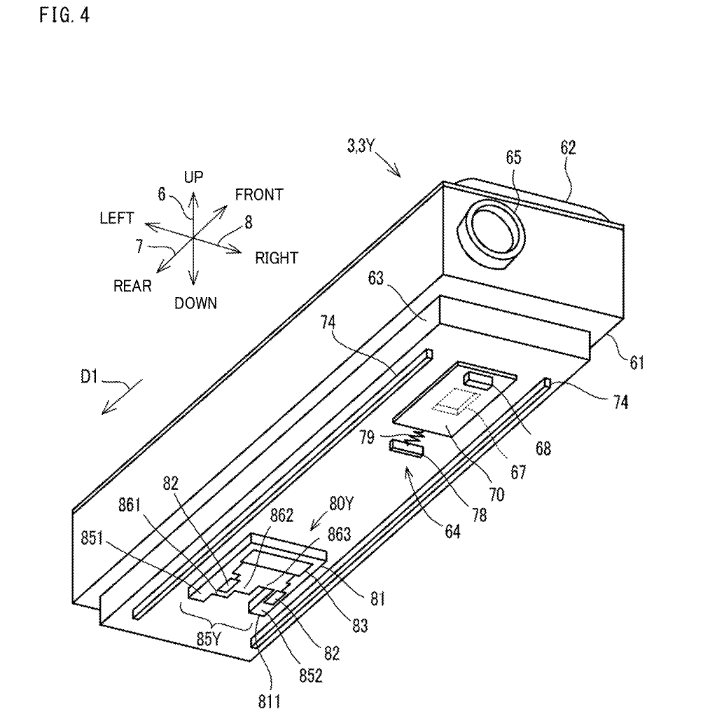

On the other hand, in the toner container 3Y of the present embodiment, a container-side compatible key 85Y (see FIG. 4) described below, provided on the toner container 3, is integrally formed with a substrate 81 of an IC chip 80Y. Accordingly, the degree of freedom in selecting attachment positions for the container-side compatible key 85Y and the IC chip 80Y on an attachment surface of the toner container 3 is increased, and cost and the number of parts are reduced by integrally configuring the container-side compatible key 85Y and the IC chip 80Y.

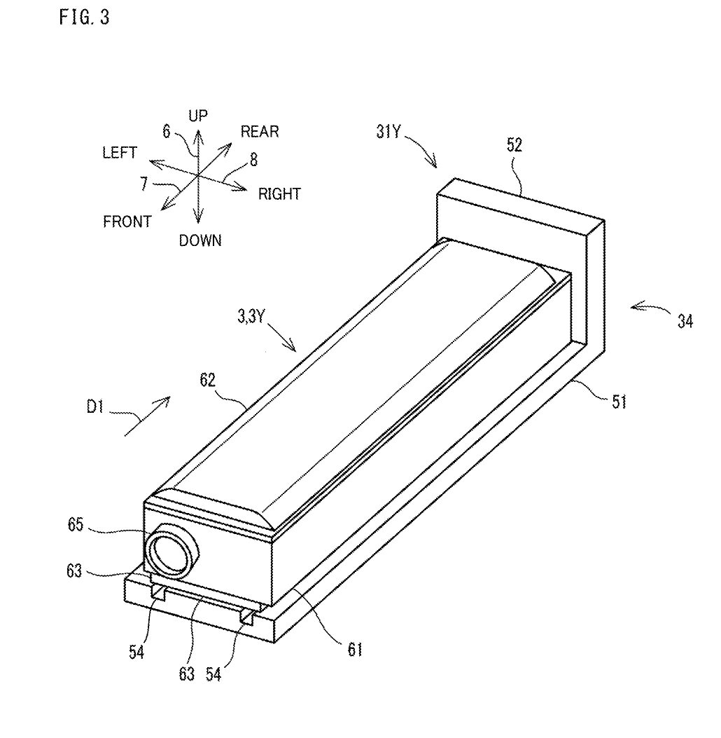

In the following, with reference to FIG. 3 to FIG. 6B, configurations of the toner container 3Y and the toner storing portion 31Y for the toner container 3Y are described in detail. It is noted that since the toner containers 3C, 3M, and 3K have substantially the same configuration as the toner container 3Y, except a configuration of the IC chip 80Y, detailed descriptions of the toner containers 3C, 3M, and 3K are omitted. In addition, since the toner storing portions 31C, 31M, and 31K have substantially the same configuration as the toner storing portion 31Y, except a configuration of a compatible member 90Y, detailed descriptions of the toner storing portions 31C, 31M, and 31K are omitted.

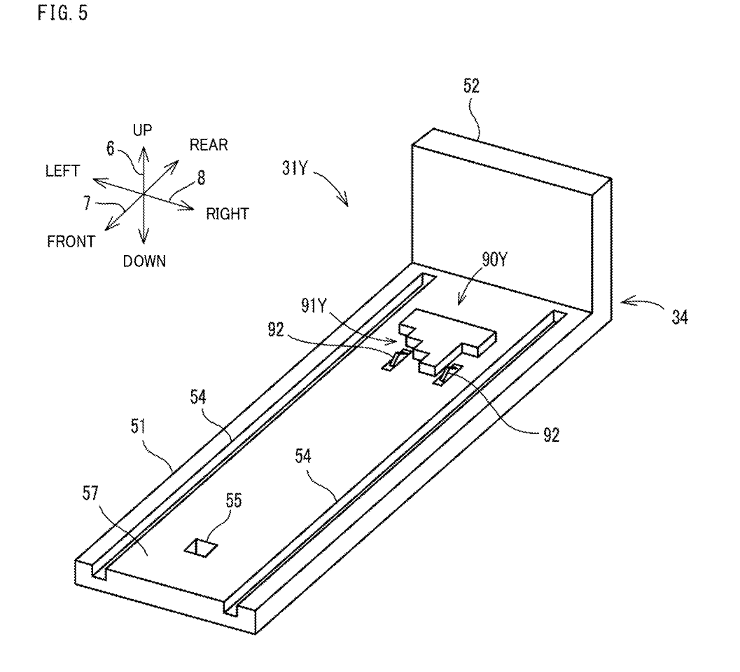

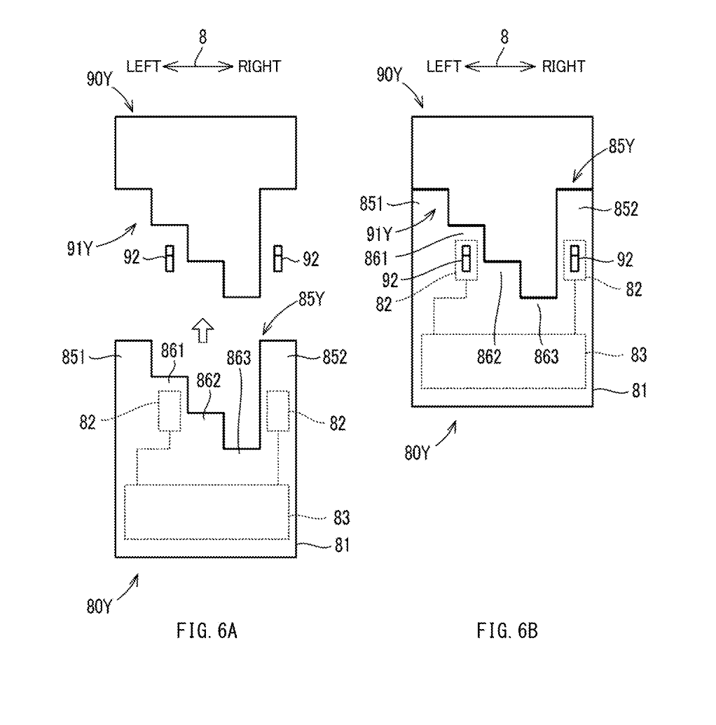

FIG. 3 is a perspective diagram showing a state in which the toner container 3Y is supported by the support frame 34 of the toner storing portion 31Y for yellow. FIG. 4 is a perspective diagram of the toner container 3Y. FIG. 5 is a perspective diagram of the support frame 34 for yellow. In addition, FIG. 6A is a schematic diagram showing a pre-engaged state of the compatible member 90Y of the toner storing portion 31Y and the container-side compatible key 85Y (see FIG. 4) of the toner container 3Y, and FIG. 6B is a schematic diagram showing an engaged state of the compatible member 90Y of the toner storing portion 31Y and the container-side compatible key 85Y (see FIG. 4) of the toner container 3Y. Here, in FIG. 3 to FIG. 5, with reference to attitudes of the support frame 34 and the toner container 3Y attached to the housing 11, a vertical direction is defined as the up-down direction 6, an insertion and extraction direction to and from the housing 11 is defined as the front-rear direction 7, and a horizontal direction when viewing the attached toner container 3Y from the front is defined as the left-right direction 8.

As shown in FIG. 3 and FIG. 5, the support frame 34 includes a support base 51 and a rear end wall 52. The support base 51 is configured to support a bottom surface 64 (see FIG. 4) of the toner container 3Y, and is formed in a plate-like shape that is longer in the front-rear direction 7. A pair of guide grooves 54 extending in the front-rear direction 7 are provided on an upper surface 57 (see FIG. 5) of the support base 51. The pair of guide grooves 54 are spaced apart from each other by a predetermined distance in the left-right direction 8. The pair of guide grooves 54 is for guiding the toner container 3Y in the front-rear direction 7, and extends linearly along the front-rear direction 7. A pair of slide rails 74 (see FIG. 4) are inserted into the pair of guide grooves 54, wherein the pair of slide rails 74 are provided on the bottom surface 64 of the toner container 3Y. With this configuration, the toner container 3Y is supported by the support frame 34 such that the toner container 3Y is horizontally slidable in the front-rear direction 7. The toner container 3Y is attached to the toner storing portion 31Y by inserting the toner container 3Y in the toner storing portion 31Y in the horizontal insertion direction D1 (an example of the attaching direction of the present disclosure, see FIG. 3), until reaching a position (an example of the attachment position of the present disclosure) where the toner container 3Y abuts against the rear end wall 52.

As shown in FIG. 5, a through hole 55 penetrating in the up-down direction 6 is formed in the support base 51. The through hole 55 is connected to a toner replenishing port (not shown) of the developing device 44. As shown in FIG. 3, in a state in which the toner container 3Y is attached in the attachment position (the position where the toner container 3Y abuts against the rear end wall 52) in the toner storing portion 31Y, a toner discharge port 67 (see FIG. 4) of the toner container 3Y comes directly above the through hole 55.

The rear end wall 52 is provided at a rear end portion of the support base 51. A drive output portion (not shown) such as a rotatably supported gear is provided on the rear end wall 52, and rotational driving force from a motor (not shown) is transmitted to the drive output portion. When the toner container 3Y is attached to the toner storing portion 31Y, the drive output portion is connected to an input gear (not shown) for rotating a conveying member (not shown) provided inside the toner container 3Y. The conveying member is rotated by the driving force transmitted from the drive output portion to the input gear. With this configuration, toner inside the toner container 3Y is conveyed toward the toner discharge port 67.

As shown in FIG. 3 and FIG. 4, the toner container 3Y is formed longer in the front-rear direction 7. The toner container 3Y includes a container body 61 and a lid 62. The container body 61 and the lid 62 may be made of synthetic resin.

The container body 61 is configured to contain toner, and has a substantially rectangular parallelepiped shape, formed to be elongated in the front-rear direction 7. Toner used by the developing device 44 for development processing is contained in the container body 61. The container body 61 has a bottom portion 63 that is supported by the support base 51 of the support frame 34. The toner discharge port 67 (see FIG. 4) for discharging toner out of the toner container 3Y is formed in the bottom portion 63 of the toner container 3Y. The toner discharge port 67 is formed on a front side of the bottom portion 63. In addition, the lid 62 is configured to close an opening portion on an upper surface of the container body 61.

A toner filling port (not shown) for filling the container body 61 with toner is formed on a front side of the container body 61, and the toner filling port is closed by a plug member 65.

As shown in FIG. 4, a plate-like shutter member 70 for opening and closing the toner discharge port 67 is provided on the bottom surface 64 of the toner container 3Y. The shutter member 70 may be made of synthetic resin. The shutter member 70 is supported by the bottom portion 63 so as to be movable between a closed position (shown in FIG. 4) where the toner discharge port 67 is closed, and an open position where the toner discharge port 67 is open. In the present embodiment, the shutter member 70 is supported by the bottom portion 63 so as to be slidable along the front-rear direction 7 by a slide support mechanism (not shown).

A spring member 79, such as a coil spring or a leaf spring, is provided on the bottom surface 64 of the toner container 3Y. One end of the spring member 79 is attached to a spring holder 78 provided on the bottom surface 64, and an opposite end is attached to a rear end of the shutter member 70. The spring member 79 is a so-called tension-spring, and is an elastic member that elastically energizes the shutter member 70 from the open position to the closed position. The spring member 79 may have any configuration as long as the spring member 79 is an elastic member that elastically energizes the shutter member 70 toward the closed position. For example, the spring member 7 may be a rubber member.

When the toner container 3Y is attached to the attachment position of the toner storing portion 31Y, a pressing portion (not shown) provided in the toner storing portion 31Y presses forward a protruding member 68 of the shutter member 70. With this configuration, when attaching the toner container 3Y, the shutter member 70 is pressed toward the front against a spring force of the spring member 79 and is moved to the open position. When the toner container 3Y is pulled out from the attachment position, the spring member 79 applies a spring force to the shutter member 70 to move the shutter member 70 from the open position to the closed position. Accordingly, when the toner container 3Y is pulled out, the shutter member 70Y is moved from the open position to the closed position.

As shown in FIG. 4, the IC chip 80Y is provided on the bottom surface 64 of the toner container 3Y. The IC chip 80Y is attached more rearwards on the bottom surface 64 than the shutter member 70.

The IC chip 80Y is a plate-like substrate 81, on which two contact terminals 82 (an example of the contact terminal and the first contact terminal of the present disclosure), and a semiconductor memory 83 (an example of the storage portion of the present disclosure), such as a chip memory or a flash memory, are mounted. Hereinafter, the semiconductor memory 83 is referred to as a memory 83. The contact terminals 82 are electrodes made of copper foil. The substrate 81 is a so-called printed board, and along with the contact terminals 82 and the memory 83, a copper foil wiring for connecting the contact terminals 82 and the memory 83 is provided on a surface of the substrate 81. The contact terminals 82 and the memory 83 are electrically connected by the copper foil wiring. The memory 83 stores information relating to toner contained in the toner container 3Y. Examples of the information relating to the toner are an amount of toner remaining in the toner container 3Y, when the toner container 3Y was stored with unused toner, and a condition of use of the unused toner (such as an upper limit of temperature in a usage environment).

In the present embodiment, the container-side compatible key 85Y, configured to only allow its associated toner container 3Y to be attached only to the toner storing portion 31Y with which the toner container 3Y has attachment compatibility, is formed integrally on the substrate 81. The container-side compatible key 85Y is a key member that allows the toner container 3Y to be selectively attached to its corresponding toner storing portion 31Y.

The container-side compatible key 85Y is formed on the substrate 81 at an end portion 811, on a front side in the insertion direction D1 of the toner container 3Y. Specifically, the end portion 811 is formed in a unique shape corresponding to the toner container 3Y to form the container-side compatible key 85Y. The container-side compatible key 85Y is the end portion 811 formed in a shape projecting and recessed in the front-rear direction 7, and as shown in FIG. 4, includes two projecting portions 851 and 852, projecting toward the insertion direction D1. The one projecting portion 851 is positioned on a left side of the end portion 811, and the other projecting portion 852 is positioned on a right side of the end portion 811. In addition, the container-side compatible key 85Y includes a step portion 861 adjacently positioned on a right side of the projecting portion 851, and step portions 862 and 863 positioned further to the right. The step portion 861 is formed in a shape that is recessed one step forward from a projecting end of the projecting portion 851. In the present embodiment, the two contact terminals 82 are respectively provided on the projecting portion 852 and the step portion 861.

As shown in FIG. 5, the compatible member 90Y corresponding to the toner container 3Y is provided on the upper surface 57 of the support base 51 of the toner storing portion 31Y. The compatible member 90Y accepts attachment of the toner container 3Y having attachment compatibility, and prohibits attachment of other incompatible toner containers 3 that do not have attachment compatibility. The compatible member 90Y includes a compatible engaging portion 91Y, configured to engage only with the container-side compatible key 85Y of the toner container 3Y having attachment compatibility. In addition, two contact terminals 92 (an example of the second contact terminal of the present disclosure) that can come into electrical contact with the contact terminals 82 of the toner container 3Y are provided on the upper surface 57 of the support base 51.

The compatible engaging portion 91Y is formed in a shape corresponding to the toner container 3Y for yellow. Specifically, the compatible engaging portion 91Y is formed in a projecting and recessed shape that can engage with the container-side compatible key 85Y of the toner container 3Y.

The two contact terminals 92 are provided on a front side of the compatible member 90Y on the upper surface 57 of the support base 51. The contact terminals 92 project upwards from slits formed in the upper surface 57, and may be bent, narrow metal plates having conductivity. The contact terminals 92 are positioned in correspondence with the contact terminals 82 of the toner container 3Y having attachment compatibility.

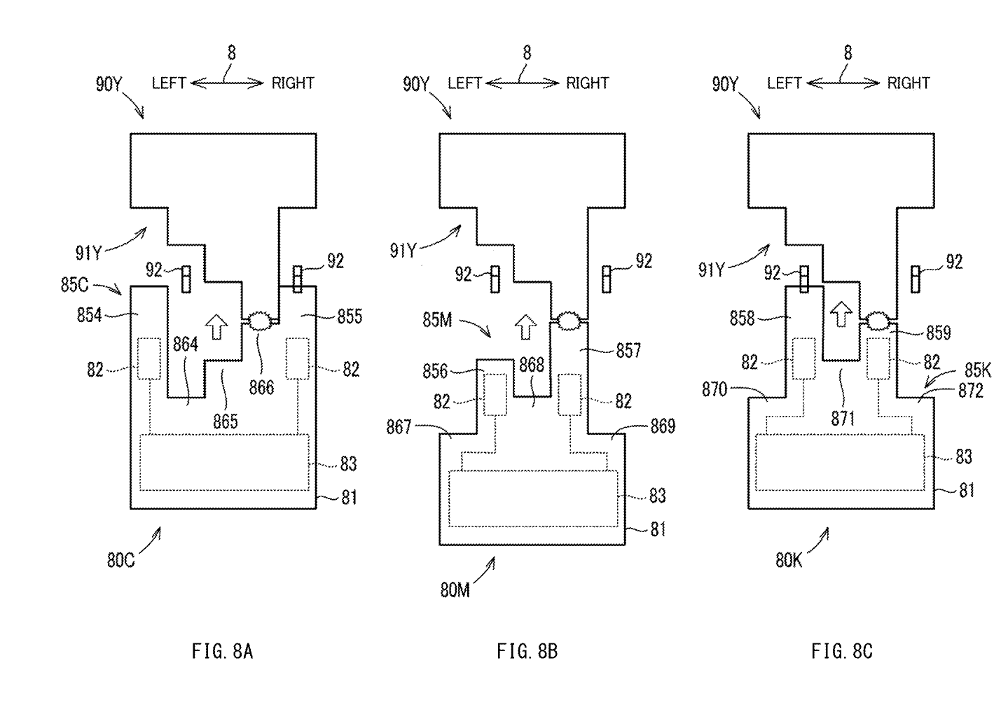

Since the compatible member 90Y is provided on the toner storing portion 31Y as described above, when the toner container 3Y is inserted in the toner storing portion 31Y and positioned at the attachment position, as shown in FIG. 6A and FIG. 6B, the container-side compatible key 85Y engages with the compatible engaging portion 91Y, and the contact terminals 82 of the toner container 3Y come in contact with the contact terminals 92. On the other hand, as shown in FIG. 8A to FIG. 8C, even if any one of the other toner containers 3 (3C, 3M, 3K) is inserted in the toner storing portion 31Y, a container-side compatible key 85C, 85M, or 85K of another toner container 3 does not engage but interferes with the compatible engaging portion 91Y. Accordingly, even if any one of the other toner containers 3 (3C, 3M, 3K) is inserted in the toner storing portion 31Y, the toner container 3 is not positioned at the attachment position, and the contact terminals 82 do not come in contact with the contact terminals 92. It is noted that the container-side compatible keys 85C, 85M, and 85K are described below.

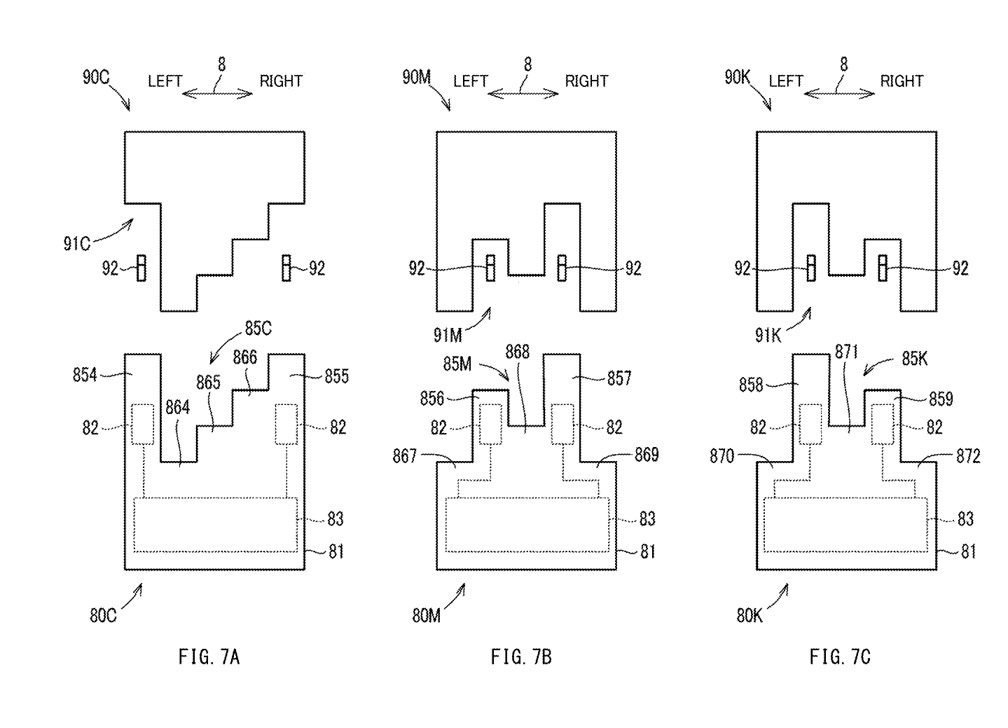

FIG. 7A is a schematic diagram showing an IC chip 80C of the toner container 3C, and a compatible member 90C of the toner storing portion 31C. The IC chip 80C has the same configuration as the IC chip 80Y described above, except that the container-side compatible key 85C has a different shape from the container-side compatible key 85Y. The container-side compatible key 85C is for allowing its associated toner container 3C to be attached only to the toner storing portion 31C with which the toner container 3C has attachment compatibility, and is a key member for allowing the toner container 3C to be selectively attached to the toner storing portion 31C.

The container-side compatible key 85C is formed integrally on the substrate 81. The container-side compatible key 85C is formed in a unique shape, projecting and recessed in the front-rear direction 7, in correspondence with the toner container 3C. The container-side compatible key 85C includes two projecting portions 854 and 855 that project toward the insertion direction D1 and are positioned on both ends of the substrate 81 in the left-right direction 8. In addition, the container-side compatible key 85C includes a plurality of step portions 864, 865, and 866, each different in step level, positioned between the projecting portions 854 and 855. The contact terminals 82 are provided on both projecting portions 854 and 855. A compatible engaging portion 91C is formed in a shape that can engage only with the container-side compatible key 85C. In addition, the contact terminals 92 are provided in positions corresponding to the contact terminals 82 of the container-side compatible key 85C.

FIG. 7B is a schematic diagram showing an IC chip 80M of the toner container 3M and a compatible member 90M of the toner storing portion 31M. The IC chip 80M has the same configuration as the IC chips 80Y and 80C described above, except that the container-side compatible key 85M has a different shape from the container-side compatible keys 85Y and 85C. The container-side compatible key 85M is for allowing its associated toner container 3M to be attached only to the toner storing portion 31M with which the toner container 3M has attachment compatibility, and is a key member for allowing the toner container 3M to be selectively attached to the toner storing portion 31M.

The container-side compatible key 85M is formed integrally on the substrate 81. The container-side compatible key 85M is formed in a unique shape, projecting and recessed in the front-rear direction 7, in correspondence with the toner container 3M. The container-side compatible key 85M includes two projecting portions 856 and 857 that project toward the insertion direction D1. In addition, the container-side compatible key 85M includes a plurality of step portions 867, 868, and 869 positioned in a way that they sandwich the projecting portions 856 and 857. The projecting portion 856 is adjacently positioned on a right side of the step portion 867 at a left end of the substrate 81, and the projecting portion 857, formed longer than the projecting portion 856 in the insertion direction D1, is adjacently positioned on a left side of the step member 869 at a right end of the substrate 81. The contact terminals 82 are provided on both projecting portions 856 and 857. A compatible engaging portion 91M is formed in a shape that can engage only with the container-side compatible key 85M. In addition, the contact terminals 92 are provided in positions corresponding to the contact terminals 82 of the container-side compatible key 85M.

FIG. 7C is a schematic diagram showing an IC chip 80K of the toner container 3K and a compatible member 90K of the toner storing portion 31K. The IC chip 80K has the same configuration as the IC chips 80Y, 80C, and 80M described above, except that the container-side compatible key 85K has a different shape from the container-side compatible keys 85Y, 85C, and 85M. The container-side compatible key 85K is for allowing its associated toner container 3K to be attached only to the toner storing portion 31K with which the toner container 3K has attachment compatibility, and is a key member for allowing the toner container 3K to be selectively attached to the toner storing portion 31K.

The container-side compatible key 85K is formed integrally on the substrate 81. The container-side compatible key 85K is formed in a unique shape, projecting and recessed in the front-rear direction 7, in correspondence with the toner container 3K. The container-side compatible key 85K includes two projecting portions 858 and 859 that project toward the insertion direction D1. In addition, the container-side compatible key 85K includes a plurality of step portions 870, 871, and 872 positioned in a way that they sandwich the projecting portions 858 and 859. The projecting portion 859 is adjacently positioned on a left side of the step portion 872 at a right end of the substrate 81, and the projecting portion 858, formed longer than the projecting portion 859 in the insertion direction D1, is adjacently positioned on a right side of the step member 870 at a left end of the substrate 81. The contact terminals 82 are provided on both projecting portions 858 and 859. A compatible engaging portion 91K is formed in a shape that can engage only with the container-side compatible key 85K. In addition, the contact terminals 92 are positioned in correspondence with the contact terminals 82 of the container-side compatible key 85K.

As described above, since the uniquely shaped container-side compatible keys 85Y, 85C, 85M, and 85K are respectively provided on the toner containers 3Y, 3C, 3M and 3K, and the uniquely shaped compatible engaging portions 91Y, 91C, 91M, and 91K are respectively provided on the toner storing portions 31Y, 31C, 31M, and 31K, it is possible to attach the toner containers 3 to the attachment positions of the toner storing portions 31 with which the toner containers 3 have the attachment compatibility, and prohibit attachment of toner containers 3 to toner storing portions 31 with which the toner containers 3 do not have attachment compatibility.

In addition, since the container-side compatible keys 85Y, 85C, 85M, and 85K on the toner containers 3 are formed integrally on the substrates 81, attachment positions of the IC chips 80Y, 80C, 80M, and 80K on the bottom surfaces 64 of the toner containers 3 have a higher degree of freedom in attachment position. In addition, by configuring the IC chips 80Y, 80C, 80M, and 80K to include the container-side compatible keys, it is possible to reduce cost and the number of parts.

It is noted that while in the configurations illustrated in the embodiment above, the IC chips 80Y, 80C, 80M, and 80K are provided on each bottom surface 64 of the toner containers 3, the present disclosure is not limited to these configurations. For example, the IC chips 80Y, 80C, 80M, and 80K may be provided on an upper surface, a side surface, a front surface, or a rear surface of the toner container 3.

In addition, while in the configuration illustrated in the embodiment above, the contact terminals 82 are provided on both the projecting portion 852 and the step portion 861 on the container-side compatible key 85Y, the present disclosure is not limited to this configuration. For example, the contact terminals 82 may each be provided on any two step portions selected from the container-side compatible key 85Y, or the contact terminals 82 may each be provided on any two of the projecting portions 851 and 852 selected from the container-side compatible key 85Y. That is, the contact terminals 82 may be provided on either or both of the projecting portion and the step portion in the container-side compatible key 85Y. It is noted that this also applies to the container-side compatible keys 85C, 85M, and 85K.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A toner container configured to be removably attached to a container attaching portion of an image forming apparatus, comprising:
a substrate on which a storage portion is mounted, the substrate being attached on a surface of a body of the toner container; and
a compatible key configured to allow the toner container to be selectively attached to the container attaching portion, the compatible key being formed integrally on the substrate.

2. The toner container according to claim 1, wherein
the compatible key includes a projecting portion and a step portion, wherein the projecting portion projects from the substrate toward an attaching direction, and the step portion has a step level corresponding to the projecting portion, and
a contact terminal electrically connected to the storage portion is disposed on either or both of the projecting portion and the step portion.

3. An image forming apparatus, comprising:
a toner container; and
a container attaching portion, to which the toner container is configured to be removably attached, wherein
the toner container includes a substrate and a compatible key, wherein the substrate, on which a storage portion is mounted, is attached on a surface of a body of the toner container, and the compatible key, formed integrally on the substrate, is configured to allow the toner container to be selectively attached to the container attaching portion, and
the container attaching portion includes a compatible member having a compatible engaging portion configured to engage only with the compatible key of the toner container having attachment compatibility with the container attaching portion.

4. The image forming apparatus according to claim 3, wherein
the compatible key includes a projecting portion and a step portion, wherein the projecting portion projects from the substrate toward an attaching direction, and the step portion has a step level corresponding to the projecting portion,
a first contact terminal electrically connected to the storage portion is provided on either or both of the projecting portion or the step portion, and
the container attaching portion includes a second contact terminal configured to come into electrical contact with the first contact terminal when the compatible key engages with the compatible engaging portion.
